(19) United States
(12) Patent Application Publication
(10) Pub. No.: US 2015/0028983 A1
(43) Pub. Date: Jan. 29, 2015

(54) CHIP ELECTRONIC COMPONENT AND MANUFACTURING METHOD THEREOF

(71) Applicant: SAMSUNG ELECTRO-MECHANICS CO., LTD., Suwon-Si (KR)

(72) Inventors: Han Wool RYU, Suwon-Si (KR); Gwang Hwan HWANG, Suwon-Si (KR); Kwi Jong LEE, Suwon-Si (KR); Hwan Soo LEE, Suwon-Si (KR); Hang Kyu CHO, Suwon-Si (KR)

(73) Assignee: SAMSUNG ELECTRO-MECHANICS CO., LTD., Suwon-Si (KR)

(21) Appl. No.: 14/261,988

(22) Filed: Apr. 25, 2014

(30) Foreign Application Priority Data
Jul. 29, 2013 (KR) 10-2013-0089619
Oct. 14, 2013 (KR) 10-2013-0122004

(51) Int. Cl. H01F 27/255; H01F 27/28; H01F 41/02; H01F 27/29

(52) U.S. Cl. CPC H01F 27/255; H01F 27/29; H01F 27/2804; H01F 41/0266
USPC 336/192; 29/846

(57) ABSTRACT

A magnetic paste composition for a chip electronic component, a chip electronic component, and a manufacturing method therof are provided. The chip electronic component is capable of being manufactured in a thin-film to allow for thinness and miniaturization thereof, thereby preventing a deterioration in efficiency thereof due to core loss even under high frequency and high current conditions. The chip electronic component exhibits high permeability, high efficiency, and a high Isat value by decreasing porosity.

### CROSS-REFERENCE TO RELATED APPLICATIONS

This application claims the priorities of Korean Patent Application Nos. 10-2013-0089619 filed on Jul. 29, 2013 and 10-2013-0122004 filed on Oct. 14, 2013 in the Korean Intellectual Property Office, the disclosures of which are incorporated herein by reference.

### TECHNICAL FIELD

The present disclosure relates to a chip electronic component, and more particularly, to a chip electronic component, provided in an information technology device, and the like, and capable of removing noise.

### BACKGROUND

An inductor, a chip electronic component, is a representative passive element configuring an electronic circuit together with a resistor and a capacitor for removing noise. The inductor may be used for configuring a resonance circuit, a filter circuit, and the like, amplifying signal in a specific frequency band through a combination thereof with the capacitor using electromagnetic characteristics.

There is a tendency for digital devices such as a mobile phone, a notebook PC, and the like, and various electrical and electronic information communication devices such as multimedia products, and the like, to be miniaturized, lightweight, and thin. The inductor has also been rapidly changed into a chip which is small and capable of being used in high density automatic surface mounting. Therefore, a thin film inductor formed by mixing a magnetic powder and a resin on a coil wire disposed using a plating process has been developed.

In addition to the tendency for gradual miniaturization, lightness, and thinness, a product having high inductance L or micro capacity, high quality factor Q, high self resonant frequency (SRF), low direct-current resistance (Rdc), and high rated current has been required.

In order to obtain high inductance from a predetermined unit volume, a material having high permeability is needed. Typically, in order to obtain high permeability, a magnetic substance having a large particle size is used.

Here, a large particle as mentioned above may deteriorate efficiency due to core loss as frequency and used current become large. Therefore, in order to prevent deterioration of efficiency at high frequency, it is required to decrease the size of the particle.

However, in a case of using the particle having a small size, since it has lower permeability than the particle having a large size, inductance may be decreased. Therefore, it is essential to increase permeability by increasing density. FIG. 1 illustrates a cross-sectional view of a thin film inductor according to the related art. Because the thin film inductor according to the related art uses a magnetic substance having uniform particle size, it has low density and high porosity, and cannot obtain sufficient permeability.

Japanese Patent Laid-Open Publication No. 2008-166455 (JP 2008-166455) discloses a coil apparatus using a magnetic layer formed of metallic magnetic powder having a particle size distribution of 5 μm to 30 μm. However, since the magnetic layer according to the related art disclosed in JP 2008-166455 is configured of magnetic substance particles having a uniform particle size, it may not secure sufficient density and sufficiently improve permeability.

### SUMMARY

An aspect of the present disclosure provides a chip electronic component capable of being manufactured in a thin film to allow for a small thickness and miniaturization thereof, while having high permeability, high efficiency, and a high Isat value by increasing density, reducing porosity, and a manufacturing method thereof.

According to an aspect of the present disclosure, a chip electronic component may include: a magnetic body including an insulating substrate, and internal conductor patterns formed on one or more surfaces of the insulating substrate. External electrodes are formed on outer surfaces of the magnetic body and connected to the internal conductor pattern parts. The magnetic body includes first magnetic particles and second magnetic particles. The first magnetic particles and the second magnetic particles are formed of an amorphous metal containing iron (Fe). The first magnetic particles are coarse powder particles having a major axis length of 15 μm or more, and the second magnetic particles are fine powder particles having a major axis length of 5 μm or less.

The first magnetic particles and the second magnetic particles may be formed of an amorphous metal further containing at least three metals in addition to iron (Fe).

The first magnetic particles and the second magnetic particles may be formed of an amorphous metal containing at least three metals selected from the group consisting of iron (Fe), silicon (Si), boron (B), chromium (Cr), nickel (Ni), cobalt (Co), and aluminum (Al).

The first magnetic particles and the second magnetic particles may be formed of an amorphous Fe—Si—B—Cr-based metal.

When a cross-section of the magnetic body is observed, a cross-sectional area ratio of the first magnetic particles to the second magnetic particles may be 10:1 to 18:1.

The first magnetic particles may have a particle size distribution D₅₀ 4 to 13.5 times greater than that of the second magnetic particles.

The first magnetic particles may have a particle size distribution D₅₀ of 18 to 22 μm.

The first magnetic particles may have a particle size distribution D₅₀, greater than that of the second magnetic particles by 15 to 18 μm.

The second magnetic particles may have a particle size distribution D₅₀ of 2 to 4 μm.

The first magnetic particles and the second magnetic particles may be mixed with each other in a weight ratio of 6:4 to 8:2.

The magnetic body may have a porosity of 20% or less.

According to another aspect of the present disclosure, a manufacturing method of a chip electronic component includes forming internal conductor patterns on one or more surfaces of an insulating substrate, and forming a magnetic body by stacking magnetic layers on upper and lower surfaces of the insulating substrate having the internal conductor patterns formed thereon and pressing the stacked magnetic layers. External electrodes are formed on outer surfaces of the magnetic body to be connected to the internal conductor patterns. The magnetic body is formed by mixing first magnetic particles and second magnetic particles; the first magnetic particles and the second magnetic particles are formed of an amorphous metal containing iron (Fe). The first magnetic particles are coarse powder particles having a major axis length of 15 μm or more, and the second magnetic particles are fine powder particles having a major axis length of 5 μm or less.

The first magnetic particles and the second magnetic particles may be formed of an amorphous metal containing at least three metals selected from the group consisting of iron (Fe), silicon (Si), boron (B), chromium (Cr), nickel (Ni), cobalt (Co), and aluminum (Al).

The first magnetic particles and the second magnetic particles may be formed of an amorphous Fe—Si—B—Cr-based metal.

The first magnetic particles and the second magnetic particles may be mixed with each other in a weight ratio of 6:4 to 8:2.

The first magnetic particles may have a particle size distribution D₅₀ 4 to 13.5 times greater than that of the second magnetic particles.

The first magnetic particles may have a particle size distribution D₅₀ of 18 to 22 μm.

The first magnetic particles may have a particle size distribution D₅₀, greater than that of the second magnetic particles by 15 to 18 μm.

The second magnetic particles may have a particle size distribution D₅₀ of 2 to 4 μm.

According to another aspect of the present disclosure, a chip electronic component is provided comprising a magnetic body including an insulating substrate having a first main surface and an opposing second main surface. A first coil-shaped internal conductor pattern is formed on the first main surface of the insulating substrate. A second coil-shaped internal conductor pattern is formed on the second main surface of the insulating substrate. The first coil-shaped conductor pattern and the second coil-shaped conductor pattern are electrically connected to each other through a conductive via in the insulating substrate. A first external electrode is formed on a first outer surface of the magnetic body and connected to the first internal conductor pattern. A second external electrode is formed on a second outer surface of the magnetic body opposing the first external electrode. The magnetic body includes first magnetic particles and second magnetic particles. The first magnetic particles and the second magnetic particles are formed of an amorphous metal containing iron (Fe). The first magnetic particles have a particle size distribution D₅₀ 4 to 13.5 times greater than that of the second magnetic particles.

The first magnetic particles may have a major axis length of 15 μm or more, and the second magnetic particles may have a major axis length of 5 μm or less

The first and second coil-shaped conductor patterns may further comprise a central core portion filled with the magnetic first and second magnetic particles.

The first magnetic particles may have a particle size distribution D₅₀ of 18 to 22 μm.

The first magnetic particles may have a particle size distribution D₅₀, greater than that of the second magnetic particles by 15 to 18 μm.

The second magnetic particles may have a particle size distribution D₅₀ of 2 to 4 μm.

The first magnetic particles and the second magnetic particles may be mixed with each other in a weight ratio of 6:4 to 8:2.

The magnetic body may have a porosity of 20% or less.

### BRIEF DESCRIPTION OF THE DRAWINGS

The above and other aspects, features and other advantages of the present disclosure will be more clearly understood from the following detailed description taken in conjunction with the accompanying drawings.

FIG. 1 is a cross-sectional view of a chip electronic component according to the related art.

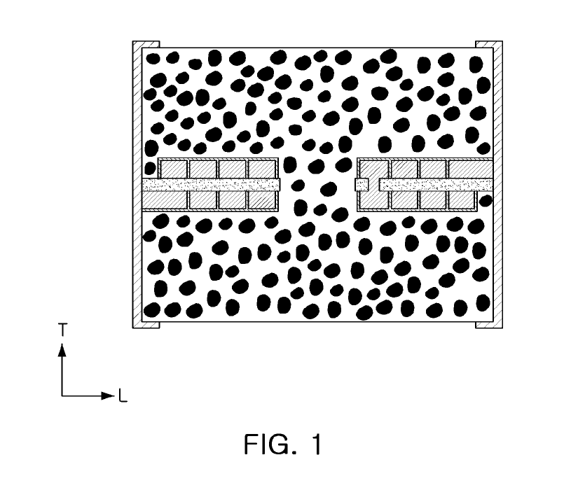

FIG. 2 is a perspective view of a chip electronic component according to an exemplary embodiment of the present disclosure.

FIG. 3 is a cross-sectional view taken along line I-I′ of FIG. 2.

FIGS. 4A through 4D are views schematically describing a manufacturing method of the chip electronic component of FIG. 2.

FIG. 5 are photographs of a cross-sectional portion of a chip electronic component according to an exemplary embodiment of the present disclosure taken in a width-thickness direction (W-T) at a magnification of 2000 times using a scanning electron microscope (SEM).

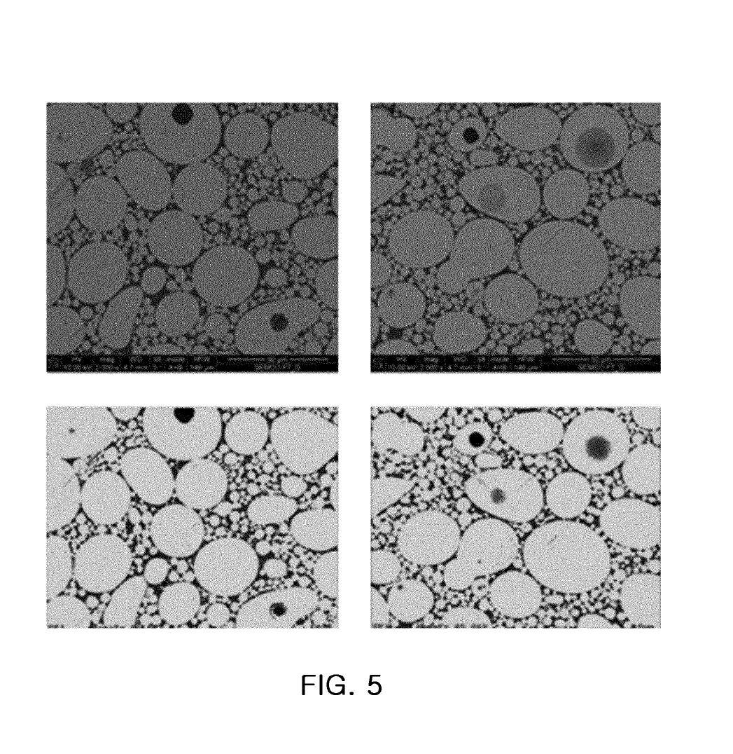

FIG. 6 are photographs of a cross-sectional portion of a chip electronic component according to another exemplary embodiment of the present disclosure taken in a width-thickness direction (W-T) at a magnification of 2000 times using a scanning electron microscope (SEM).

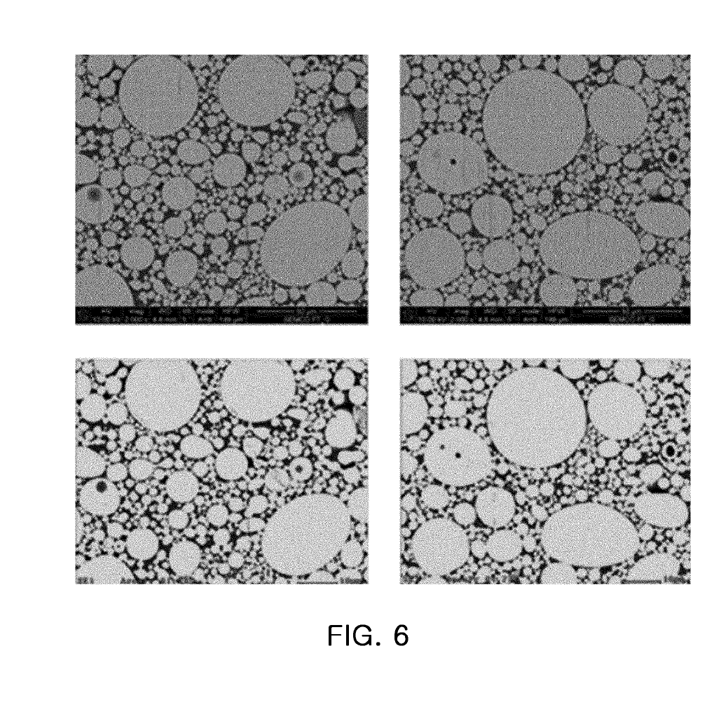

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Chip Electronic Component

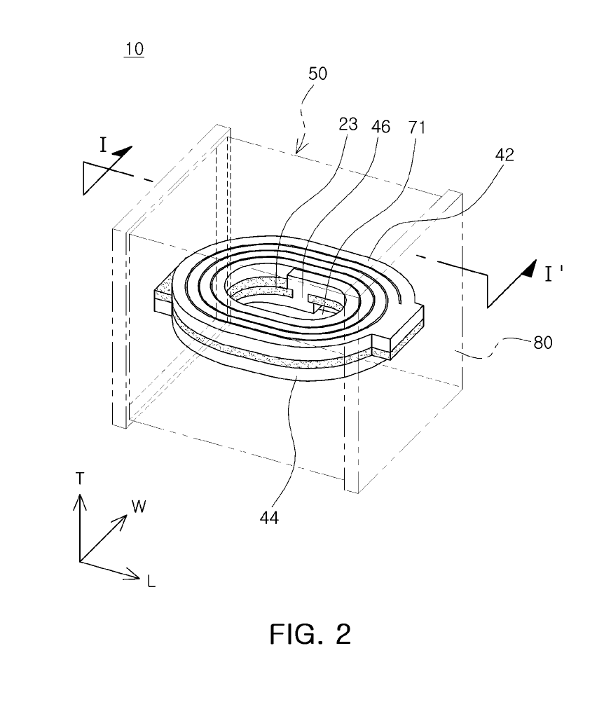

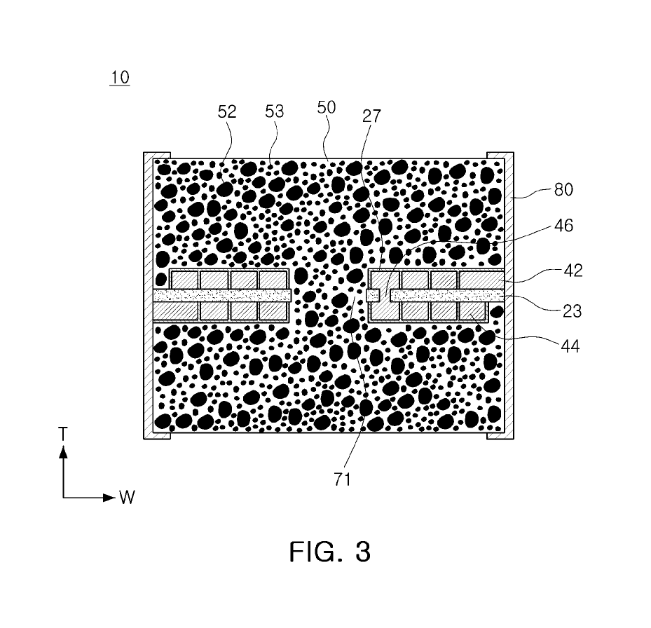

FIG. 2 is a perspective view of a chip electronic component according to an exemplary embodiment of the present disclosure and FIG. 3 is a cross-sectional view taken along line I-I′ of FIG. 2.

Referring to FIGS. 2 and 3, a thin film inductor 10 used for a power line of a power supply circuit is exemplified as a chip electronic component, by way of example. As the chip electronic component, chip beads, a chip filter, and the like, may be appropriately used, in addition to a chip inductor.

The thin film inductor 10 may include a magnetic body 50, an insulating substrate 23, internal conductor patterns 42 and 44, and external electrodes 80.

The magnetic body 50 may have a hexahedral shape, and L, W and T shown in FIG. 2 refers to a length direction, a width direction, and a thickness direction thereof, respectively.

The magnetic body 50 may include both surfaces in the thickness direction, both end surfaces in the length direction, and both surfaces in the width direction. The magnetic body 50 may have a rectangular parallelepiped shape in which a length thereof is greater than a width thereof.

A material for the insulating substrate 23 formed in the magnetic body 50 is not particularly limited, as long as it may form the internal conductor patterns 42 and 44 by an electroplating process, and the insulating substrate 23 may be formed as a thin film including an epoxy resin, or the like.

The internal conductor pattern part 42 having a coil-shaped pattern may be formed on one surface of the insulating substrate 23 and the internal conductor pattern part 44 having the coil-shaped pattern may also be formed on the other surface of the insulating substrate 23. One edge of the internal conductor pattern part 42 formed on one surface of the insulating substrate 23 may be exposed to one end surface of the magnetic body 50 in the length direction, and one edge of the internal conductor pattern part 44 formed on the other surface of the insulating substrate 23 may be exposed to the other end surface of the magnetic body 50 in the length direction.

In addition, the internal conductor pattern parts 42 and 44 formed on one surface and the other surface of the insulating substrate 23 may be electrically connected to each other through a via electrode 46 formed in the insulating substrate 23.

A hole penetrating through the insulating substrate 23 may be formed in the central portion of the insulating substrate 23, and the hole may be filled with a magnetic substance such as a metallic based soft magnetic material, or the like, forming the magnetic body to thereby form a core part 71. Inductance may be improved by forming the core part 71 filled with the magnetic substance.

The external electrodes 80 may be formed on the both end surfaces of the magnetic body 50 in the length direction to be connected to the exposed portions of the internal conductor pattern parts 42 and 44. The internal conductor patterns 42 and 44, the via electrode 46, and the external electrodes 80 may be formed of a metal having excellent electrical conductivity, and may be, for example, formed of silver (Ag), copper (Cu), nickel (Ni), aluminum (Al), or an alloy thereof.

Meanwhile, the magnetic body 50 may include first magnetic particles 52 and second magnetic particles 53 and in this case, the first magnetic particles 52 and the second magnetic particles 53 may be formed of an amorphous metal containing iron (Fe). The first magnetic particles may be coarse powder particles having a major axis length of 15 μm or more, and the second magnetic particles may be fine powder particles having a major axis length of 5 μm or less.

Referring to FIG. 3, which shows a cross-sectional view of the thin film inductor 10 according to the exemplary embodiment of the present disclosure, the magnetic body 50 may be formed by mixing the first magnetic particles 52, the coarse powder particles; and the second magnetic particles 53, the fine powder particles.

The magnetic body 50 may be formed by mixing the first magnetic particles 52 and the second magnetic particles 53 that have different particle size distributions, such that a density of the component may be improved and the permeability thereof may be significantly improved to thereby allow for increases in inductance and the Isat value.

The first magnetic particles 52 and the second magnetic particles 53 may be formed of an amorphous metal further containing at least three metals, in addition to iron (Fe).

The first magnetic particles 52, the coarse powder particles, and the second magnetic particles 53, the fine powder particles, are formed of the amorphous metal, whereby performance such as inductance and the like, may be improved. Further, in a case in which the particles are formed of the amorphous metal, the particles may be formed to have spherical shapes, to thereby improve the density, and decrease the porosity.

The first magnetic particles 52 and the second magnetic particles 53 may formed of an amorphous metal containing at least three metals selected from the group consisting of iron (Fe), silicon (Si), boron (B), chromium (Cr), nickel (Ni), cobalt (Co), and aluminum (Al), and may be formed of, for example, an amorphous Fe—Si—B—Cr-based metal.

The first magnetic particles 52 and the second magnetic particles 53 may be formed of the same kind of amorphous metal and may be formed of different kinds of amorphous metal.

The first magnetic particles 52 may have a particle size distribution D₅₀ which is 4 to 13.5 times greater than that of the second magnetic particles 53.

Here, when an area per view of a photograph imaged using a scanning electron microscope (SEM) at a magnification of 1,000 was 12.5 μm², particle sizes of magnetic particles present in an area corresponding to a cross section of the component were calculated and arranged in an increasing order of particle size, and then the particle size of a rank in which the accumulation of the respective particle sizes reaches 50% of the total view was defined as the particle size distribution D₅₀.

When the particle size distribution D₅₀ of the first magnetic particles 52 is 4 to 13.5 times greater than that of the second magnetic particles 53, the density may be significantly improved, porosity decreased, and permeability may be increased to allow for a significant increase in inductance (see Table 3).

More specifically, the particle size distribution D₅₀ of the first magnetic particles 52 may be greater than that of the second magnetic particles 53 by 15 to 18 μm. In the case in which a difference between the particle size distributions D₅₀ of the first magnetic particles 52 and the second magnetic particles 53 is below 15 μm or is greater than 18 μm, an increase in density is insignificant, whereby the improvement in inductance may decrease.

The particle size distribution D₅₀ of the first magnetic particles 52 may be 18 to 22 μm. When the particle size distribution D₅₀ of the first magnetic particles 52 is 18 to 22 μm, core loss in high frequencies may be small and high permeability may be secured. When the particle size distribution D₅₀ of the first magnetic particles 52 is below 18 μm, sufficient permeability may not be secured, while when the particle size distribution D₅₀ of the first magnetic particles 52 is greater than 22 μm, efficiency of the component under high frequency and high current conditions may be significantly decreased.

In addition, the particle size distribution D₅₀ of the second magnetic particles 53 may be 2 to 4 μm. When the particle size distribution D₅₀ of the second magnetic particles 53 is 2 to 4 μm, the second magnetic particles 53 may be mixed with the first magnetic particles 52, whereby the density may be significantly improved and permeability may be significantly improved. When the particle size distribution D₅₀ of the second magnetic particles 53 is below 2 μm or is greater than 4 μm, the density may be insignificantly improved and permeability may decrease.

The first magnetic particles and the second magnetic particles may be mixed with each other in a weight ratio of 6:4 to 8:2, thereby forming the magnetic body 50.

In this case, when a cross-section of the magnetic body 50 is observed, a cross-sectional area ratio of the first magnetic particles 52, the coarse powder particles, to the second magnetic particles 53, the fine power particles, may be 10:1 to 18:1. When a cross-sectional area ratio of the first magnetic particles 52 to the second magnetic particles 53 is within the range as mentioned above, the density may be significantly improved and high permeability may be exhibited.

The magnetic body 50 according to the exemplary embodiment of the present disclosure may satisfy a porosity of 20% or less.

In the case in which magnetic particles having a particle size distribution D₅₀ of 3 μm were uniformly formed (Comparative Example 1), the inverse of the porosity (1/porosity) was merely 62.7%, but in the case in which the first magnetic particles having a particle size distribution D₅₀ of 20 μm and the second magnetic particles having a particle size distribution D₅₀ of 3 μm are mixed in a weight ratio of 7:3 according to an exemplary embodiment of the present disclosure (Inventive Example 5), inverse of the porosity was 76.1%, an improvement of about 14% or more, as compared to the Comparative Example 1 (see Table 1).

Therefore, the thin film inductor 10 according to an exemplary embodiment of present disclosure may provide high permeability, high efficiency, and a high Isat value (see Table 2).

### Manufacturing Method of Chip Electronic Component

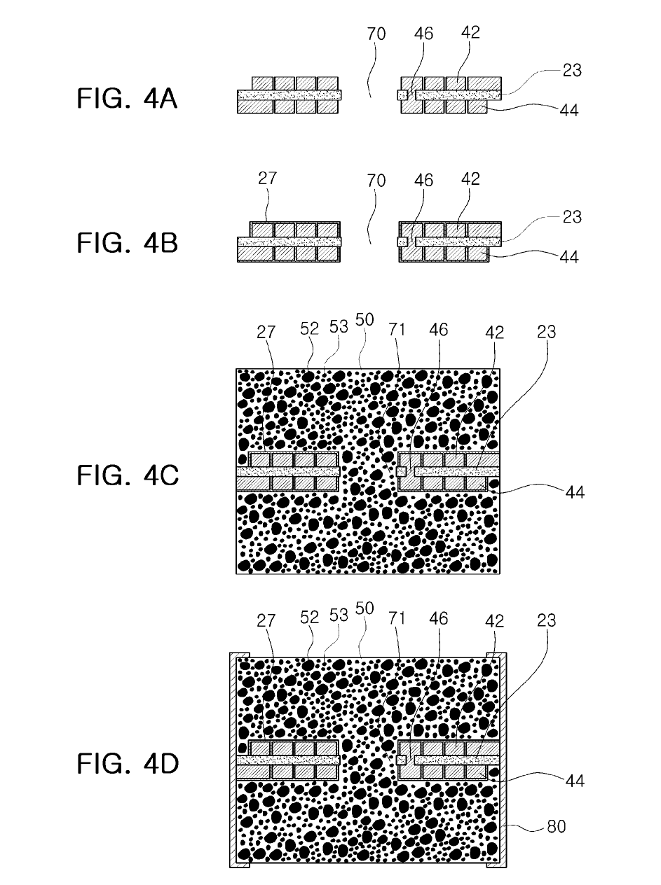

FIGS. 4A through 4D are views schematically describing a manufacturing method of the chip electronic component of FIG. 2.

Referring to FIG. 4A, internal conductor patterns 42 and 44 are formed on main one surface and the other opposing main surface of the insulating substrate 23. As a method of forming the internal conductor patterns 42 and 44, a process such as plating, etching, printing, a transfer process, or the like, which are used as a manufacturing processes for a printed circuit board may be used. In certain embodiments, plating may be used to form the internal conductor patterns 42 and 44 having an increased thickness. The internal conductor patterns 42 and 44 may be formed of a metal having excellent electrical conductivity, and may be, for example, formed of silver (Ag), copper (Cu), nickel (Ni), aluminum (Al), or an alloy thereof.

A hole is formed in a portion of the insulating substrate 23 and is filled with a conductive material, such that the via electrode 46 may be formed, and the internal conductor pattern parts 42 and 44 formed on one main surface and the other opposing main surface of the insulating substrate 23 may be electrically connected to each other through the via electrode 46.

A hole 70 may be formed in the central portion of the insulating substrate 23 to penetrate through the insulating substrate 23. The hole 70 may be formed by drilling, laser processing, sand blasting, punching, or the like, but is not limited thereto.

Referring to FIG. 4B, the internal conductor patterns 42 and 44 formed on one surface and the other surface of the insulating substrate 23 may be coated with an insulating layer 27.

Next, referring to FIG. 4C, the magnetic body 50 may be formed by stacking magnetic layers on upper and lower surfaces of the insulating substrate 23 having the internal conductor pattern parts 42 and 44 formed thereon. The magnetic body 50 may be formed by stacking the magnetic layers on the both surfaces of the insulating substrate 23 and pressing the stacked magnetic layers by laminating or a hydrostatic pressure process. In this case, the hole 70 may be filled with a magnetic substance, thereby forming the core part 71.

In this case, the magnetic body 50 may include the first magnetic particles and the second magnetic particles and in this case, the first magnetic particles and the second magnetic particles are formed of an amorphous metal containing iron (Fe). The first magnetic particles may be coarse powder particles having a major axis length of 15 μm or more, and the second magnetic particles may be fine powder particles having a major axis length of 5 μm or less.

Hereinafter, a detailed description of the first magnetic particles and second magnetic particles applied to the manufacturing method of the chip electronic component according to the exemplary embodiment of the present disclosure, in the same manner to those of the foregoing embodiment, will be omitted.

Finally, referring to FIG. 4D, the thin film inductor 10 may be manufactured by forming the external electrodes 80 on both end surfaces of the magnetic body 50 in the length direction. The external electrodes 80 may be formed to be connected to the edges of the internal conductor patterns 42 and 44 and may be formed by a dipping method, or the like. The external electrodes may be formed of a metal having excellent electrical conductivity, and may be, for example, formed of silver (Ag), copper (Cu), nickel (Ni), aluminum (Al), or an alloy thereof.

The following Tables 1 and 2 show results of inverse of porosity, permeability, and inductance values of thin film inductors according to weight ratios in which the first magnetic particles and the second magnetic particles formed of an amorphous Fe—Si—B—Cr-based metal are mixed.

TABLE 1

| | Mixed Weight Ratio | | | |
|---|---|---|---|---|
| | First | Second | Inverse of | |
| | Magnetic | Magnetic | Porosity | Perme- |
| | particles | particles | (1/Porosity) | ability |
| | (D₅₀ = 20 μm) | (D₅₀ = 3 μm) | (%) | (μ) |
| Inventive | 3 | 7 | 67.7 | 17.6 |
| Example 1 | | | | |
| Inventive | 5 | 5 | 72.9 | 23.8 |
| Example 2 | | | | |
| Inventive | 6 | 4 | 76.0 | 27.7 |
| Example 3 | | | | |
| Inventive | 6.6 | 3.4 | 75.6 | 27.7 |
| Example 4 | | | | |
| Inventive | 7 | 3 | 76.1 | 30.2 |
| Example 5 | | | | |
| Inventive | 7.6 | 2.4 | 75.0 | 27.6 |
| Example 6 | | | | |
| Comparative | 0 | 10 | 62.7 | 13.3 |
| Example 1 | | | | |
| Comparative | 10 | 0 | 67.4 | 20.7 |
| Example 2 | | | | |

TABLE 2

| | 1 MHz | | | 3 MHz | | | 9 MHz | | |
|---|---|---|---|---|---|---|---|---|---|
| | Ls (uH) | Q | Rs | Ls (uH) | Q | Rs | Ls (uH) | Q | Rs |
| Inventive | 0.78 | 41.00 | 0.12 | 0.78 | 58.33 | 0.24 | 0.78 | 45.53 | 1.01 |
| Example 1 | | | | | | | | | |
| Inventive | 0.97 | 48.20 | 0.13 | 0.97 | 53.54 | 0.34 | 0.96 | 27.55 | 2.02 |
| Example 2 | | | | | | | | | |
| Inventive | 1.09 | 51.99 | 0.14 | 1.09 | 48.13 | 0.41 | 1.09 | 22.84 | 2.73 |
| Example 3 | | | | | | | | | |
| Inventive | 1.11 | 50.89 | 0.14 | 1.10 | 46.25 | 0.43 | 1.10 | 22.14 | 2.83 |
| Example 4 | | | | | | | | | |
| Inventive | 1.18 | 54.93 | 0.14 | 1.18 | 47.15 | 0.47 | 1.18 | 20.33 | 3.34 |
| Example 5 | | | | | | | | | |
| Inventive | 11 | 51.85 | 0.13 | 1.09 | 45.71 | 0.45 | 1.09 | 21.18 | 2.96 |
| Example 6 | | | | | | | | | |
| Comparative | 0.63 | 31.20 | 0.12 | 0.62 | 61.41 | 0.19 | 0.62 | 87.97 | 0.41 |
| Example 1 | | | | | | | | | |
| Comparative | 0.92 | 45.12 | 0.13 | 0.91 | 45.18 | 0.38 | 0.91 | 24.03 | 2.18 |
| Example 2 | | | | | | | | | |

The following Table 3 shows results of density, permeability and inductance values according to particle size ratios of the first magnetic particles and the second magnetic particles formed of an amorphous Fe—Si—B—Cr based metal.

TABLE 3

| | First | Mixed Weight | | | |
|---|---|---|---|---|---|
| | Magnetic | Ratio (First | | | |
| | particles | Magnetic | Inverse of | | |
| | (D₅₀)/Second | particles: | Porosity | | |
| | Magnetic | Second | (1/ | Perme- | |
| | particles | Magnetic | Porosity) | ability | Ls |
| | (D₅₀) | particles) | (%) | (μ) | (uH) |
| Inventive | 8.0 | 7:3 | 80 | 33 | 1.15 |
| Example 7 | | | | | |
| Inventive | 6.0 | 7:3 | 75 | 30 | 1.0 |
| Example 8 | | | | | |
| Inventive | 4.0 | 7:3 | 74 | 28 | 0.9 |
| Example 9 | | | | | |
| Inventive | 6.7 | 7:3 | 76 | 28 | 0.9 |
| Example 10 | | | | | |
| Inventive | 13.3 | 7:3 | 84 | 33 | 1.15 |
| Example 11 | | | | | |
| Inventive | 4.6 | 7:3 | 65 | 25 | 0.75 |
| Example 12 | | | | | |
| Inventive | 9.3 | 7:3 | 78 | 29 | 0.95 |
| Example 13 | | | | | |
| Inventive | 7.3 | 7:3 | 76 | 28 | 0.9 |
| Example 14 | | | | | |
| Comparative | 3 μm Only | — | 63 | 13 | 0.6 |
| Example 3 | | | | | |
| Comparative | 4 μm Only | — | 64 | 15 | 0.65 |
| Example 4 | | | | | |
| Comparative | 5 μm Only | — | 64 | 17 | 0.68 |
| Example 5 | | | | | |
| Comparative | 11 μm Only | — | 65 | 18 | 0.70 |
| Example 6 | | | | | |
| Comparative | 14 μm Only | — | 66 | 19 | 0.75 |
| Example 7 | | | | | |
| Comparative | 20 μm Only | — | 67 | 20 | 0.78 |
| Example 8 | | | | | |
| Comparative | 24 μm Only | — | 68 | 23 | 0.8 |
| Example 9 | | | | | |

As set forth above, according to exemplary embodiments of the present disclosure, the chip electronic component may be manufactured in a thin-film to allow for thinness and miniaturization thereof, may prevent a deterioration in efficiency thereof due to core loss even under high frequency and high current conditions, and may have high permeability, high efficiency, and a high Isat value by increasing the density.

While exemplary embodiments have been shown and described above, it will be apparent to those skilled in the art that modifications and variations could be made without departing from the spirit and scope of the present disclosure as defined by the appended claims.

What is claimed is:

1. A chip electronic component, comprising:
a magnetic body including an insulating substrate;
internal conductor patterns formed on one or more surfaces of the insulating substrate; and
external electrodes formed on outer surfaces of the magnetic body and connected to the internal conductor patterns,
wherein the magnetic body includes first magnetic particles and second magnetic particles;
the first magnetic particles and the second magnetic particles are formed of an amorphous metal containing iron (Fe);
the first magnetic particles are coarse powder particles having a major axis length of 15 μm or more, and
the second magnetic particles are fine powder particles having a major axis length of 5 μm or less.

2. The chip electronic component of claim 1, wherein the first magnetic particles and the second magnetic particles are formed of an amorphous metal further containing at least three metals in addition to iron (Fe).

3. The chip electronic component of claim 1, wherein the first magnetic particles and the second magnetic particles are formed of an amorphous metal containing at least three metals selected from the group consisting of iron (Fe), silicon (Si), boron (B), chromium (Cr), nickel (Ni), cobalt (Co), and aluminum (Al).

4. The chip electronic component of claim 1, wherein the first magnetic particles and the second magnetic particles are formed of an amorphous Fe—Si—B—Cr-based metal.

5. The chip electronic component of claim 1, wherein when a cross-section of the magnetic body is observed, a cross-sectional area ratio of the first magnetic particles to the second magnetic particles is 10:1 to 18:1.

6. The chip electronic component of claim 1, wherein the first magnetic particles have a particle size distribution D₅₀ 4 to 13.5 times greater than that of the second magnetic particles.

7. The chip electronic component of claim 1, wherein the first magnetic particles have a particle size distribution D₅₀ of 18 to 22 μm.

8. The chip electronic component of claim 1, wherein the first magnetic particles have a particle size distribution D₅₀, greater than that of the second magnetic particles by 15 to 18 μm.

9. The chip electronic component of claim 1, wherein the second magnetic particles have a particle size distribution D₅₀ of 2 to 4 μm.

10. The chip electronic component of claim 1, wherein the first magnetic particles and the second magnetic particles are mixed with each other in a weight ratio of 6:4 to 8:2.

11. The chip electronic component of claim 1, wherein the magnetic body has a porosity of 20% or less.

12. A manufacturing method of a chip electronic component, the manufacturing method comprising:
forming internal conductor patterns on one or more surfaces of an insulating substrate;
forming a magnetic body by stacking magnetic layers on upper and lower surfaces of the insulating substrate having the internal conductor patterns formed thereon and pressing the stacked magnetic layers; and
forming external electrodes on outer surfaces of the magnetic body to be connected to the internal conductor patterns,
wherein the magnetic body is formed by mixing first magnetic particles and second magnetic particles;
the first magnetic particles and the second magnetic particles are formed of an amorphous metal containing iron (Fe);
the first magnetic particles are coarse powder particles having a major axis length of 15 μm or more, and
the second magnetic particles are fine powder particles having a major axis length of 5 μm or less.

13. The manufacturing method of claim 12, wherein the first magnetic particles and the second magnetic particles are formed of an amorphous metal containing at least three metals selected from the group consisting of iron (Fe), silicon (Si), boron (B), chromium (Cr), nickel (Ni), cobalt (Co), and aluminum (Al).

14. The manufacturing method of claim 12, wherein the first magnetic particles and the second magnetic particles are formed of an amorphous Fe—Si—B—Cr-based metal.

15. The manufacturing method of claim 12, wherein the first magnetic particles and the second magnetic particles are mixed with each other in a weight ratio of 6:4 to 8:2.

16. The manufacturing method of claim 12, wherein the first magnetic particles have a particle size distribution D₅₀ 4 to 13.5 times greater than that of the second magnetic particles.

17. The manufacturing method of claim 12, wherein the first magnetic particles have a particle size distribution D₅₀ of 18 to 22 μm.

18. The manufacturing method of claim 12, wherein the first magnetic particles have a particle size distribution D₅₀, greater than that of the second magnetic particles by 15 to 18 μm.

19. The manufacturing method of claim 12, wherein the second magnetic particles have a particle size distribution D₅₀ of 2 to 4 μm.

20. A chip electronic component, comprising: a magnetic body including an insulating substrate having a first main surface and an opposing second main surface;
a first coil-shaped internal conductor pattern formed on the first main surface of the insulating substrate;
a second coil-shaped internal conductor pattern formed on the second main surface of the insulating substrate substrate,
wherein the first coil-shaped conductor pattern and the second coil-shaped conductor pattern are electrically connected to each other through a conductive via in the insulating substrate;
a first external electrode formed on a first outer surface of the magnetic body and connected to the first internal conductor pattern,
a second external electrode formed on a second outer surface of the magnetic body opposing the first external electrode;
wherein the magnetic body includes first magnetic particles and second magnetic particles, and
the first magnetic particles and the second magnetic particles are formed of an amorphous metal containing iron (Fe), and
wherein the first magnetic particles have a particle size distribution D₅₀ 4 to 13.5 times greater than that of the second magnetic particles.

21. The chip electronic component of claim 20, wherein the first magnetic particles have a major axis length of 15 μm or more, and
the second magnetic particles have a major axis length of 5 μm or less.

22. The chip electronic component of claim 20, wherein the first and second coil-shaped conductor patterns further comprise a central core portion filled with the magnetic first and second magnetic particles.

23. The chip electronic component of claim 21, wherein the first magnetic particles have a particle size distribution D₅₀ of 18 to 22 μm.

24. The chip electronic component of claim 21, wherein the first magnetic particles have a particle size distribution D₅₀, greater than that of the second magnetic particles by 15 to 18 μm.

25. The chip electronic component of claim 1, wherein the second magnetic particles have a particle size distribution D₅₀ of 2 to 4 μm.

26. The chip electronic component of claim 21, wherein the first magnetic particles and the second magnetic particles are mixed with each other in a weight ratio of 6:4 to 8:2.

27. The chip electronic component of claim 21, wherein the magnetic body has a porosity of 20% of less.
